(19) United States
(12) Patent Application Publication
(10) Pub. No.: US 2013/0326077 A1
(43) Pub. Date: Dec. 5, 2013

(54) METHOD FOR CONNECTING A REMOTE NETWORK AND SYSTEM FOR CONNECTING A REMOTE NETWORK

(71) Applicant: RSUPPORT CO., LTD., Seoul (KR)

(72) Inventor: Hyung Su Seo, Gyeonggi-do (KR)

(73) Assignee: RSUPPORT CO., LTD., Seoul (KR)

(21) Appl. No.: 13/899,427

(22) Filed: May 21, 2013

(30) Foreign Application Priority Data
May 21, 2012 (KR) 10-2012-0053492

(51) Int. Cl. H04L 29/06

(52) U.S. Cl. CPC H04L 65/1069
USPC 709/228

(57) ABSTRACT

Disclosed is a remote network connection method of easily establishing network connection between an information processing apparatus and a terminal device. The remote network connection method includes connecting to a gateway, transmitting connection information including at least one of gateway connection information and information processing apparatus identification information to a server, and setting network connection to a terminal device connected to the gateway on the basis of the connection information through the gateway. Accordingly, it is possible to easily establish the remote network connection between the information processing apparatus and the terminal device through a mobile communication network using a push message function of the server, without a separate network connection setup between the information processing apparatus and the terminal device. It is also possible to reduce the network maintenance cost.

### CLAIM FOR PRIORITY

This application claims priority to Korean Patent Application No. 2012-0053492 filed on May 21, 2012 in the Korean Intellectual Property Office (KIPO), the entire contents of which are hereby incorporated by reference.

### BACKGROUND OF INVENTION

1. Technical Field

Example embodiments of the present invention relate in general to network connection and more specifically to a remote network connection method and remote network connection system capable of easily performing remote network connection.

2. Related Art

Remote personal computer (PC) control is a technology for remotely connecting to and controlling a PC positioned far away or distributed and for allowing the remote use of a PC of a user through the Internet, that is, using all functions of the PC positioned far away through a screen of a computer connected through the Internet.

Due to such convenience, the remote control has been widely used to individual users in addition to company users. In past, the remote control was typically used for a company to monitor and manage the company users' computers. However, the individual users may increasingly control at home their PCs located at office or control at office their PCs located at home using a remote control tool.

As connection to the Internet using a mobile terminal such as a smartphone has been widely used, an application has been developed to remotely control a smartphone through a PC.

However, in order to remotely control a smartphone through a PC, network connection should be established between the PC and the smartphone through a USB, WiFi, Bluetooth, or mobile communication network (3G, 4G, etc.). When the PC and the smartphone fails to be connected using the USB, WiFi, or Bluetooth, or the PC and the smartphone are connected using the mobile communication network, a detailed description about a remote network connection method between the PC and the smartphone is not presented.

### SUMMARY OF INVENTION

Accordingly, example embodiments of the present invention are provided to substantially obviate one or more problems due to limitations and disadvantages of the related art.

Example embodiments of the present invention provide a remote network connection method for easily performing remote network connection.

Example embodiments of the present invention also provide a remote network connection system for performing the remote network connection method.

In some example embodiments, a remote network connection method performed by an information processing apparatus includes connecting to a gateway, transmitting connection information including at least one of gateway connection information and information processing apparatus identification information to a push server, and setting network connection to a terminal device connected to the gateway on the basis of the connection information through the gateway.

The remote network connection method may further include transmitting authentication information to the terminal device through the gateway after the transmitting of connection information including at least one of the gateway connection information and the information processing apparatus identification information to a push server.

The push server may be set for connection to the terminal device.

The transmitting of connection information including at least one of the gateway connection information and the information processing apparatus identification information to the push server may include transmitting at least one of an IP address and port number of the gateway, and a name, manufacturing company, IP address, and MAC address of the information processing apparatus to the push server.

In other example embodiments, a remote network connection method performed by a terminal device includes: receiving connection information including at least one of gateway connection information and information processing apparatus identification information from a push server, connecting to a gateway on the basis of the received connection information, and setting connection to the information processing apparatus through the gateway.

The setting of connection to the information processing apparatus through the gateway may include receiving authentication information from the information processing apparatus and performing authentication if the received authentication information corresponds to stored authentication information. The receiving of connection information including at least one of the gateway connection information and the information processing apparatus identification information from the push server may include receiving, by a first module for receiving a push message from the push server, the connection information including at least one of the gateway connection information and the information processing apparatus identification information from the push server.

The connecting to the gateway on the basis of the received connection information may include: providing, by the first module, a second module registered in the first module with the connection information received from the push server; and connecting, by the second module, to the gateway on the basis of the gateway connection information of the received connection information.

The connecting, by the second module, to the gateway on the basis of the gateway connection information of the provided connection information may include: determining, by the second module, whether the information processing apparatus identification information of the provided connection information corresponds to the stored information processing apparatus identification information; and connecting to the gateway on the basis of the provided gateway connection information if it is determined that the information processing apparatus identification information corresponds to the stored information processing apparatus identification information.

The connecting to the gateway on the basis of the received connection information may include: providing, by the first module, a registered second module with indication information corresponding to the received connection information; and connecting, by the second module, to the gateway on the basis of the previously stored gateway connection information when the indication information is provided.

The connecting to the gateway on the basis of the received connection information may include connecting to the gateway on the basis of at least one of an IP address and port number of the gateway, and a name, manufacturing company, IP address, and MAC address of the information processing apparatus received from the registered push server.

In still other example embodiments, a remote network connection method includes: connecting, by an information processing apparatus, to a gateway to transmit connection information including at least one of gateway connection information and information processing apparatus identification information to a push server; transmitting, by the push server, the connection information received from the information processing apparatus to a terminal device having connection to the push server through a push message; and connecting, by the terminal device, to the gateway on the basis of the connection information received from the push server and setting network connection to the information processing apparatus connected to the gateway.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view illustrating a remote network connection system according to an embodiment of the present invention;

FIG. 2 is a flowchart illustrating a remote network connection method according to an embodiment of the present invention;

FIG. 3 is a flowchart illustrating a remote network connection method of an information processing apparatus according to an embodiment of the present invention;

FIG. 4 is a flowchart illustrating a remote network connection method of a terminal device according to an embodiment of the present invention;

FIG. 5 is a block diagram showing a configuration of an information processing apparatus according to an embodiment of the present invention;

FIG. 6 is a block diagram showing a configuration of a terminal device according to an embodiment of the present invention.

### DESCRIPTION OF EXAMPLE EMBODIMENTS

While the invention is susceptible to various modifications and alternative forms, specific embodiments thereof are shown by way of example in the drawings and will herein be described in detail.

However, it should be understood that the particular embodiments are not intended to limit the present disclosure to specific forms, but rather the present disclosure is meant to cover all modification, similarities, and alternatives which are included in the spirit and scope of the present disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention will be described below in more detail with reference to the accompanying drawings. In describing the invention, to facilitate the entire understanding of the invention, like numbers refer to like elements throughout the description of the figures, and a repetitive description on the same element is not provided.

Hereinafter, the information processing apparatus according to an embodiment of the present invention may include a variety of digital information processing apparatus such as a desktop computer, notebook computer, palmtop computer, ultra mobile personal computer (UMPC), tablet PC, personal digital assistant (PDA), web pad, mobile phone, etc.

Also, a terminal device 400 according to an embodiment may include a mobile communication terminal device such as a smartphone, mobile phone, personal digital assistant (PDA), etc. and a variety of digital information processing apparatus such as a portable multimedia player (PMP), smart player, pad-type terminal device, etc.

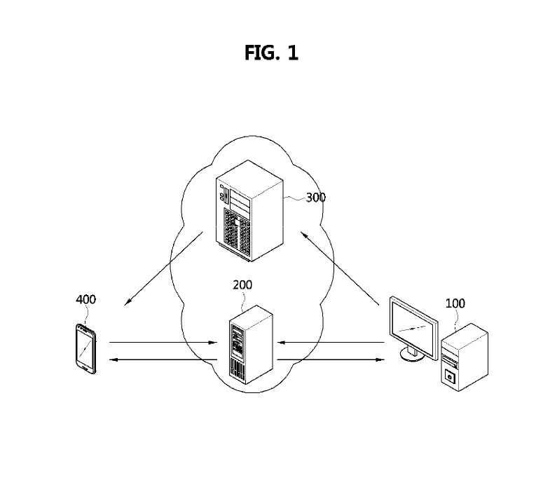

FIG. 1 is a conceptual view illustrating a network connection system according to an embodiment of the present invention.

Referring to FIG. 1, the network connection system according to an embodiment of the present invention may include an information processing apparatus 100, a gateway 200, a push server 300, and a terminal device 400.

First, the information processing apparatus 100 transmits at least one of gateway connection information and information processing apparatus identification information to the push server 300, and connects to the registered gateway 200.

Also, the information processing apparatus 100 transmits authentication information to the terminal device 400 for performing network connection, through the gateway 200, receives an authentication completion message from the terminal device 400, and then controls the terminal device 400 on the basis of an input user control signal.

When the information processing apparatus 100 and the terminal device 400 request network connection, the gateway 200 determines whether a terminal device identifier registered from the information processing apparatus 100 is the same as, or corresponds to, a terminal device identifier received from the terminal device 400.

The gateway 200 connects to the information processing apparatus 100 and the terminal device 400, respectively, when the identifiers are the same or correspond to each other.

Also, after connecting to the information processing apparatus 100 and terminal device 400, respectively, the gateway 200 intermediates data transfer between the information processing apparatus 100 and terminal device 400 using the same or corresponding identifier.

The push server 300 receives at least one of the gateway connection information and the information processing apparatus identification information and transmits the received at least one of the gateway connection information and the information processing apparatus identification information to the terminal device 400.

Here, the push server 300 may, for example, utilize a push message like a Google server when the push server 300 transmits the received at least one of the gateway connection information and the information processing apparatus identification information to the terminal device 400. In this case, it is assumed that an application for receiving the push message from the Google server has been previously installed in the terminal device 400.

The terminal device 400 receives at least one of the gateway connection information and the information processing apparatus identification information from the push server 300 and connects to the gateway 200 on the basis of the received gateway connection information and the information processing apparatus identification information.

Also, the terminal device 400 receives authentication information, such as an identification (ID), a password, an e-mail address, etc. to determine whether the received authentication information corresponds to the stored authentication information. The terminal device 400 transmits an authentication completion message to the information processing apparatus 100 if it is determined that the received authentication information corresponds to the stored authentication information.

In the network connection system according to an embodiment of the present invention, the gateway connection information can be transmitted to the terminal device 400 utilizing a push message function of the push server 300, thereby easily performing the network connection between the information processing apparatus 100 and the terminal device 400 without a separate network setup between the information processing apparatus 100 and the terminal device 400.

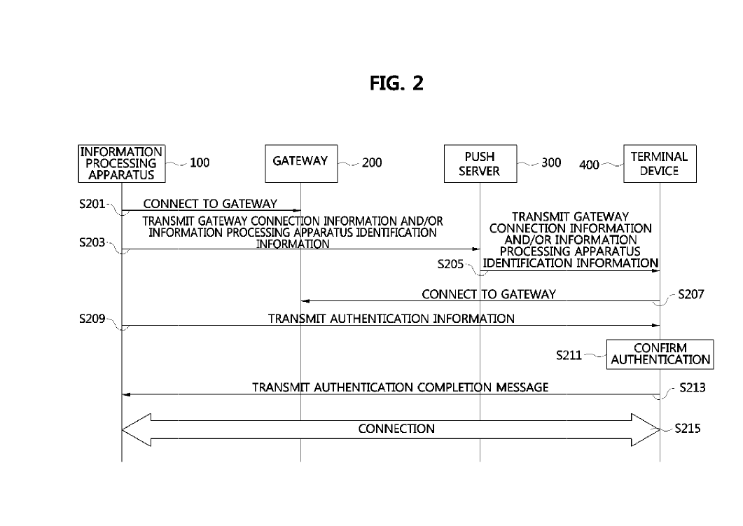

FIG. 2 is a flowchart illustrating a remote network connection method according to an embodiment of the present invention.

Referring to FIG. 2, the information processing apparatus 100 connects to the gateway 200 for exchanging data with the terminal device 400 when a network connection instruction signal is received from a user (S201).

Here, the information processing apparatus 100 may perform operation S201 when the information processing apparatus 100 fails to connect to the terminal device 400 through a universal serial bus (USB), WiFi, wired LAN, or Bluetooth, when the information processing apparatus 100 is set for the user to preferentially perform the connection through a mobile communication network (3G, 4G, etc.), or when there is a user's input.

Then, the information processing apparatus 100 transmits at least one of connection information about the gateway 200 and identification information about the information processing apparatus 100 to the push server 300 (S203).

Here, the connection information about the gateway 200 may include an IP address, a port number, etc. of the gateway, and the identification information about the information processing apparatus 100 may include a name, a manufacturing company, an IP address, MAC information, etc. of the information processing apparatus.

The push server 300 receives at least one of the gateway connection information and the information processing apparatus identification information from the information processing apparatus 100, includes the received at least one of the gateway connection information and the information processing apparatus identification information in a push message, and transmits the push message to the terminal device 400 corresponding to the received at least one of the gateway connection information and the information processing apparatus identification information.

Here, the push server 300 may transmit the received at least one of the gateway connection information and the information processing apparatus identification information to the terminal device 400, for example, utilizing a push message like that of a Google server. In this case, it is assumed that an application for receiving the push message from the Google server is previously installed in the terminal device 400.

The terminal device 400 receives at least one of the gateway connection information and the information processing apparatus identification information included in the push message from the push server 300, and connects to the gateway 200 on the basis of the received at least one of the gateway connection information and the information processing apparatus identification information (S207).

When the terminal device 400 completes the connection to the gateway 200, the information processing apparatus 100 transmits the input authentication information to the terminal device 400 according to an input user control signal (S209).

Here, the authentication information may include an ID, a password, an e-mail address, etc., and the authentication information may be displayed on a screen such that a user of the information processing apparatus 100 may check details input by the user.

Subsequently, the terminal device 400 receives the authentication information from the information processing apparatus 100 and performs an authentication procedure of determining whether the received authentication information is the same as, or corresponds to, the previously stored authentication information (S211).

Then, the terminal device 400 transmits an authentication completion message to the information processing apparatus 100 if it is determined that the received authentication information is the same as, or corresponds to, the stored authentication information.

Through operation S11, the network connection between the information processing apparatus 100 and the terminal device 400 is completed (S215).

In an embodiment of the present invention, the network connection between the information processing apparatus 100 and the terminal device 400 has been described to be completed through the authentication procedure of operations S209 to S213. However, in another embodiment of the present invention, without operations S209 to S213, the network connection between the information processing apparatus 100 and the terminal device 400 may be completed when the gateway connection of the information processing apparatus 100 and terminal device 400 is completed.

In the network connection system according to an embodiment of the present invention, the gateway connection information can be transmitted to the terminal device 400 utilizing a push message function of the push server 300, thereby easily performing the network connection between the information processing apparatus 100 and the terminal device 400 without a separate network setup between the information processing apparatus 100 and the terminal device 400.

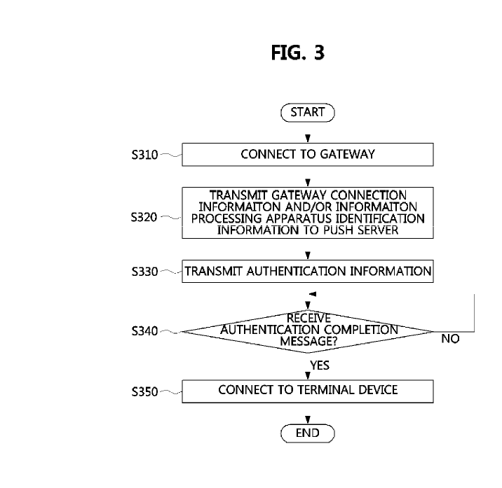

FIG. 3 is a flowchart illustrating a remote network connection method of an information processing apparatus according to an embodiment of the present invention.

Referring to FIG. 3, the information processing apparatus connects to the gateway for exchanging data with the terminal device when a network connection instruction signal is received from a user (S310).

Afterwards, the information processing apparatus transmits at least one of the gateway connection information and the information processing apparatus identification information to the push server 300 (S320).

Here, the information processing apparatus transmits a terminal device identifier as well as at least one of the gateway connection information and the information processing apparatus identification information to the push server 300.

Also, the gateway connection information may include an IP address, a port number, etc. of the gateway, and the identification information about the information processing apparatus 100 may include a name, a manufacturing company, an IP address, and MAC information of the information processing apparatus.

For convenience of description, it has been described that operation S310 where the information processing apparatus connects to the registered gateway is performed prior to operation S320. However, operations S310 and S320 may be performed in reverse order or simultaneously.

The information processing apparatus transmits the input authentication information to the terminal through the gateway according to the input user control signal (S330).

The authentication information may include at least one of an ID, a password, and an e-mail address.

Afterwards, the information processing apparatus determines whether an authentication completion message is received from the terminal device (S340), and establishes a network connection to the terminal device when it is determined that the authentication completion message is received (S350).

In an embodiment of the present invention, it has been described that the network connection to the terminal device is established through transmission of the authentication information of operation S330 and reception of the authentication completion message of operation S340. However, in another embodiment, operations S330 and S340 may not be performed.

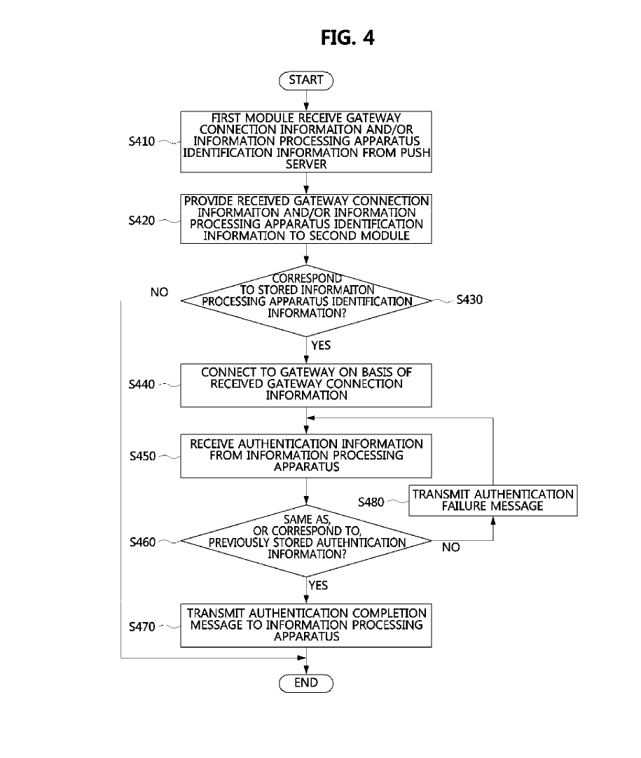

FIG. 4 is a flowchart illustrating a remote network connection method of a terminal device according to an embodiment of the present invention.

The terminal device according to an embodiment of the present invention connects to the gateway on the basis of at least one of the gateway connection information and the information processing apparatus identification information received through the push message from the registered push server, and transmits an authentication completion message to the information processing apparatus when the received authentication information corresponds to the stored authentication information.

Hereinafter, assuming that the terminal device according to an embodiment of the present invention has a first module for receiving a push message from a push server and a second module for receiving at least one of data and indication information from the first module to connect to the gateway, which are installed therein, each operation performed by the terminal device will be described in detail.

Referring to FIG. 4, the first module installed in the terminal device receives at least one of the gateway connection information and the information processing apparatus identification information from the push server (S410).

The first module installed in the terminal device provides the second module with at least one of the gateway connection information and the information processing apparatus identification information received through operation S410 (S420).

The second module installed in the terminal device determines whether the information processing apparatus identification information received from the first module through operation S420 corresponds to the previously stored information processing apparatus identification information (S430), and connects to the gateway on the basis of the received gateway connection information when it is determined that the received information processing apparatus identification information corresponds to the stored information processing apparatus identification information (S440).

Here, operation S430 in which it is determined whether the received information processing apparatus identification information corresponds to the previously stored information processing apparatus identification information may or may not be optionally performed.

Furthermore, the information processing apparatus identification information may include a name, a manufacturing company, an IP address, and MAC information of the information processing apparatus, and the gateway connection information may include an IP address, a port number, etc. of the gateway.

Subsequently, the terminal device receives the authentication information from the information processing apparatus (S450) and determines whether the received authentication information is the same as or corresponds to the previously stored authentication information (S460).

The terminal device generates an authentication completion message to transmit the generated authentication completion message to the information processing apparatus if it is determined that the authentication information received through operation S460 is the same as, or corresponds to, the previously stored authentication information (S470).

The terminal device generates an authentication failure message to transmit the generated authentication failure message to the information processing apparatus if it is determined that the authentication information received through operation S460 is not the same as, or does not correspond to, the previously stored authentication information (S480), and then the processing may return to operation S450 and perform the next operations.

In the remote network connection method according to an embodiment of the present invention, it has been described that the first module installed in the terminal device provides the second module with at least one of the gateway connection information and the information processing apparatus identification information received from the registered push server and the second module connects to the gateway on the basis of the gateway connection information received from the first module. However, in another embodiment of the present invention, the first module may receive at least one of the gateway connection information and the information processing apparatus identification information from the registered push server and then provide the second module with indication information for indicating connection to the gateway, and the second module may connect to the gateway on the basis of the gateway connection information previously stored according to the indication information provided from the first module.

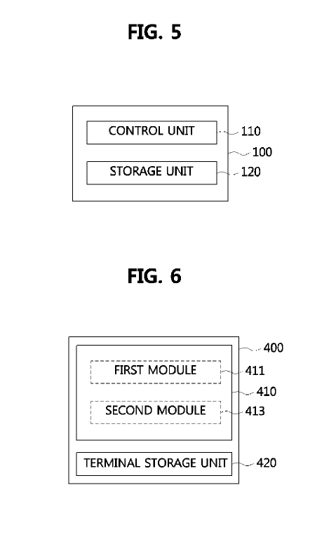

FIG. 5 is a block diagram showing a configuration of an information processing apparatus according to an embodiment of the present invention.

Referring to FIG. 5, the information processing apparatus 100 according to an embodiment of the present invention may include a control unit 110 and a storage unit 120.

First, the control unit 110 receives a network connection instruction signal from a user and then connects to the gateway on the basis of the received network connection instruction signal.

Here, the control unit 110 may connect to the gateway when connection through a USB, WiFi, Wired LAN, and Bluetooth is failed with a terminal device for performing network connection, when connection through a mobile communication network is set to be preferentially performed, or when there is an input signal for connection through the mobile communication network.

Also, the control unit 110 reads at least one of the gateway connection information and the information processing apparatus identification information from the storage unit 120 to transmit the read at least one of the gateway connection information and the information processing apparatus identification information to the previously registered push server.

Also, the control unit 110 transmits authentication information including at least one of an ID, a password, and an e-mail address to the terminal device according to the input user control signal.

Also, the control unit 110 may generate a message indicating that network connection to the terminal device has been completed to control a display unit (not shown) such that the display unit can display the generated message, when the authentication completion message responding to the transmitted authentication information is received from the terminal device.

The storage unit 120 may be configured with a large-scale nonvolatile storage device (for example, a hard disk drive), and may store identification information about the information processing apparatus 100, gateway connection information, and an identifier of the terminal device to be controlled.

FIG. 6 is a block diagram showing a configuration of a terminal device according to an embodiment of the present invention.

Referring to FIG. 6, the terminal device 400 according to an embodiment of the present invention may include a terminal control unit 410 and a terminal storage unit 420.

First, the terminal control unit 410 may include a first module 411 and a second module 413, connects to the gateway on the basis of at least one of the gateway connection information and the information processing apparatus identification information included in the push message received from the push server, and transmits an authentication completion message to the information processing apparatus when the authentication information received form the information processing apparatus corresponds to the authentication information stored in the terminal storage unit 420.

Here, it is assumed that the first module 411 is previously installed in the terminal device as an application for receiving the push message from the push server.

For example, the first module 411 may transmit information included in the push message to another module registered in the first module 411 as a Google client application for receiving the push message from the Google server.

Also, it is assumed that the second module 413 is previously installed in the terminal device as an application for connecting to the gateway.

In particular, the first module 411 receives at least one of the gateway connection information and the information processing apparatus identification information from the registered push server and provides the second module 413 with the received gateway connection information and information processing apparatus identification information.

Alternatively, the first module 411 receives at least one of the gateway connection information and the information processing apparatus identification information from the registered push server and then provides the second module 413 with indication information corresponding to the received gateway connection information and information processing apparatus identification information.

Here, the indication information may include a gateway connection instruction, message, event, etc.

The second module 413 connects to the gateway on the basis of the gateway connection information provided from the first module 411 when the information processing apparatus identification information stored in the terminal storage unit 420 corresponds to the information processing apparatus identification information provided from the first module 411.

Alternatively, the second module 413 connects to the gateway on the basis of the gateway connection information (for example, a gateway IP address, a gateway port number, etc.) stored in the terminal storage unit 420 when the indication information is provided from the first module 411.

Here, the indication information may include a gateway connection instruction, message, event, etc.

The terminal storage unit 420 may store a list of information processing apparatuses capable of network connection, a gateway IP address, a gateway port number, information processing apparatus identification information, etc.

Here, the terminal storage unit 420 may update the gateway IP address, gateway port number, etc. whenever the terminal device 400 connects to the gateway.

Also, the terminal storage unit 420 may store application programs such as the first module 411 and the second module 413 for network connection to the information processing apparatus.

In the remote network connection method and remote network connection system according to an embodiment of the present invention, the information processing apparatus can transmit the gateway connection information and the information processing apparatus identification information to the push server, and the push server can transmit the gateway connection information and the information processing apparatus identification information to a terminal device using a push message function, thereby establishing network connection between the information processing apparatus and the terminal device over the mobile communication network.

Accordingly, it is possible to easily establish the network connection between the information processing apparatus and the terminal device through the mobile communication network using the push message function of the server, without a separate network connection setup between the information processing apparatus and the terminal device. It is also possible to reduce the network maintenance cost.

While the example embodiments of the present invention and their advantages have been described in detail, it should be understood that various changes, substitutions, and alterations may be made herein without departing from the scope of the invention.

1. A remote network connection method performed by an information processing apparatus for establishing remote network connection to a terminal device, the remote network connection method comprising:
connecting to a gateway;
transmitting connection information including at least one of gateway connection information and information processing apparatus identification information to a push server; and
setting network connection to a terminal device connected to the gateway on the basis of the connection information through the gateway.

2. The remote network connection method of claim 1, further comprising transmitting authentication information to the terminal device through the gateway after the transmitting of connection information including at least one of the gateway connection information and the information processing apparatus identification information to a push server.

3. The remote network connection method of claim 1, wherein the push server is set to be connected to the terminal device.

4. The remote network connection method of claim 1, wherein the transmitting of connection information including at least one of the gateway connection information and the information processing apparatus identification information to the push server comprises transmitting at least one of an IP address and port number of the gateway, and a name, manufacturing company, IP address, and MAC address of the information processing apparatus to the push server.

5. A remote network connection method performed by a terminal device having remote network connection to the information processing apparatus, the remote network connection method comprising:
receiving connection information including at least one of gateway connection information and information processing apparatus identification information from a push server;
connecting to a gateway on the basis of the received connection information; and
setting connection to the information processing apparatus through the gateway.

6. The remote network connection method of claim 5, wherein the setting of connection to the information processing apparatus through the gateway comprises receiving authentication information from the information processing apparatus and performing authentication if the received authentication information corresponds to stored authentication information.

7. The remote network connection method of claim 5, wherein the receiving of connection information including at least one of the gateway connection information and the information processing apparatus identification information from the push server comprises receiving, by a first module for receiving a push message from the push server, the connection information including at least one of the gateway connection information and the information processing apparatus identification information from the push server.

8. The remote network connection method of claim 7, wherein the connecting to the gateway on the basis of the received connection information comprises:
providing, by the first module, a second module registered in the first module with the connection information received from the push server; and
connecting, by the second module, to the gateway on the basis of the gateway connection information of the received connection information.

9. The remote network connection method of claim 8, wherein the connecting, by the second module, to the gateway on the basis of the gateway connection information of the provided connection information comprises:
determining, by the second module, whether the information processing apparatus identification information of the provided connection information corresponds to the stored information processing apparatus identification information; and
connecting to the gateway on the basis of the provided gateway connection information if it is determined that the information processing apparatus identification information corresponds to the stored information processing apparatus identification information.

10. The remote network connection method of claim 7, wherein the connecting to the gateway on the basis of the received connection information comprises:
providing, by the first module, a registered second module with indication information corresponding to the received connection information; and
connecting, by the second module, to the gateway on the basis of the previously stored gateway connection information when the indication information is provided.

11. The remote network connection method of claim 5, wherein the connecting to the gateway on the basis of the received connection information comprises connecting to the gateway on the basis of at least one of an IP address and port number of the gateway, and a name, manufacturing company, IP address, and MAC address of the information processing apparatus received from the registered push server.

12. A remote network connection method comprising:
connecting, by an information processing apparatus, to a gateway to transmit connection information including at least one of gateway connection information and information processing apparatus identification information to a push server;
transmitting, by the push server, the connection information received from the information processing apparatus to a terminal device having connection to the push server through a push message; and
connecting, by the terminal device, to the gateway on the basis of the connection information received from the push server and setting network connection to the information processing apparatus connected to the gateway.
